(19) United States
(12) Patent Application Publication
(10) Pub. No.: US 2018/0047488 A1
(43) Pub. Date: Feb. 15, 2018

(54) RARE EARTH PERMANENT MAGNET AND PRODUCTION METHOD OF RARE EARTH PERMANENT MAGNET

(71) Applicant: IHI CORPORATION, Tokyo (JP)

(72) Inventors: Hidekazu TOMONO, Tokyo (JP); Haruki EGUCHI, Tokyo (JP); Natsuki YONEYAMA, Tokyo (JP); Isao NAKANOWATARI, Tokyo (JP); Keisuke NAGAO, Tokyo (JP); Hiroo TAKAHASHI, Tokyo (JP)

(73) Assignee: IHI CORPORATION, Tokyo (JP)

(21) Appl. No.: 15/797,841

(22) Filed: Oct. 30, 2017

Related U.S. Application Data
(63) Continuation of application No. PCT/JP2016/063515, filed on Apr. 28, 2016.

(30) Foreign Application Priority Data
Apr. 30, 2015 (JP) 2015-092885
Apr. 30, 2015 (JP) 2015-092887

(51) Int. Cl. H01F 1/057; B22F 9/04; H01F 41/02; B22F 3/16; B22F 3/24; C22C 30/02; B22F 9/24

(52) U.S. Cl. CPC H01F 1/0577; C22C 30/02; B22F 9/04; B22F 9/24; B22F 3/16; B22F 3/24; H01F 41/0266; C22C 2202/02; B22F 2301/355; B22F 2009/043; B22F 2003/248; B22F 2202/05

(57) ABSTRACT

A rare earth permanent magnet comprising a main phase containing: one or more elements R selected from a group consisting of Nd and Pr; one or more elements L selected from a group consisting of Co, Be, Li, Al and Si; one or more elements A selected from a group consisting of Tb, Sm, Gd, Ho and Er; Fe; and B, wherein crystals forming the main phase belong to P4₂/mnm, and some B atoms occupying a 4f site are substituted by atoms of the elements L.

### TECHNICAL FIELD

The present disclosure relates to a rare earth permanent magnet containing neodymium, iron, and boron.

### BACKGROUND ART

As a technique of improving the magnetic properties of a rare earth permanent magnet containing neodymium (Nd), iron (Fe), and boron (B), known is a magnet in which Fe is substituted by cobalt (Co) (PTL 1). PTL 1 comprehensively measures the coercive force Hc, residual magnetic flux density Br, maximum energy product BHₘₐₓ and other properties of a permanent magnet in which Fe is substituted by other atoms, and indicates that the magnetic properties of the permanent magnet have been improved.

Moreover, PTL 2 discloses a rare earth sintered magnet containing, in terms of wt %, 25 to 35% of R (R is at least one type of rare earth element including Y, and Nd occupying R is 50 at % or more), 0.8 to 1.5% of B, and, as needed, 8% or less of M (at least one type selected from Ti, Cr, Ga, Mn, Co, Ni, Cu, Zn, Nb, and Al), and remainder being T (Fe or Fe and Co).

As another proposal for improving the magnetic properties of a rare earth permanent magnet, there is a nano composite magnet comprising a two phase composite structure having a hard magnetic phase of nano particles formed from Nd, Fe, and B as its core, and a soft magnetic phase of predetermined nano particles as its shell. This nano composite magnet is able to improve the saturation magnetization, particularly when adopting a shell covering the core with a grain boundary formed from ultrafine particles of a soft magnetic body having a particle size of 5 nm or less, because a favorable exchange interaction will occur between the hard/soft magnetic phases of the core and the shell.

PTL 3 discloses a nano composite magnet having Nd₂Fe₁₄B compound particles as its core, and having Fe particles as its shell. By using FeCo alloy nano particles comprising high saturation magnetization as the shell component, the saturation magnetization of the nano composite magnet can be further improved. PTL 4 discloses a nano composite magnet in which a core of a NdFeB hard magnetic phase is covered with a shell of an FeCo soft magnetic phase.

PTL 5 discloses an anisotropic bulk nano composite rare earth permanent magnet in which the composition of a magnetically hard phase defined based on atomic percent is RₓT_{100-x-y}M_{y} (wherein R is selected from rare earth, yttrium, scandium, or a combination thereof; T is selected from one or more types of transition metals; M is selected from group IIIA elements, group IVA elements, group VA elements, or a combination thereof; x is greater than the stoichiometric amount of R in the corresponding rare earth transition metal compound; and y is 0 to approximately 25), and at least one type of magnetically soft phase includes at least one type of soft magnetic material containing Fe, Co, or Ni.

Nevertheless, with the nano composite rare earth permanent magnet disclosed in PTL 5, the soft phase is formed via a metallurgical process. Thus, the particle size of the particles forming the soft phase is large, and there is a possibility that the exchange interaction will be insufficient. Furthermore, when the reducing power is weak, the alloy nano particles tend to become a mere aggregate of single layer nano particles, and the intended nano composite structure cannot be obtained. Accordingly, it is anticipated that there may be cases where the magnetic properties of the foregoing nano composite rare earth permanent magnet are not improved effectively.

NPTL 1 discloses a method of preparing FeCo nano particles at a high temperature. Nevertheless, the coercive force H_{cj} of the Nd₂Fe₁₄B particles prepared at a high temperature are not favorable.

Moreover, conventionally, known is a type in which carbon (C) is included in the rare earth permanent magnet, and B is substituted by C. Nevertheless, according to NPTL 2 to NPTL 5, with a rare earth permanent magnet in which B is substituted by C, it is known that the curie temperature will decrease, and that the saturation magnetization and residual magnetic flux density Br will deteriorate considerably. Moreover, in the analysis performed based on the first-principle calculation, when C atoms and N atoms are introduced as the substitutional atoms of B atoms, such C atoms and N atoms form a covalent bond with the atoms existing in their periphery. Because this kind of rare earth permanent magnet will be substantially short of unpaired electrons that are essential for a magnetic body, the magnetic properties, in particular the residual magnetic flux density Br, will be low.

### CITATION LIST

### Patent Literature

[PTL 1] U.S. Pat. No. 5,645,651
[PTL 2] Japanese Patent Application Publication No. 2003-217918
[PTL 3] Japanese Patent Application Publication No. 2008-117855
[PTL 4] Japanese Patent Application Publication No. 2010-74062
[PTL 5] Japanese Unexamined Patent Application Publication (Translation of PCT Application) No. 2008-505500

### Non-Patent Literature

[NPTL 1] G. S. Chaubey, J. P. Liu et al., J. Am. Chem. Soc. 129, 7214 (2007)
[NPTL 2] F. Leccabue, J. L. Sanchez, L. Pareti, F. Bolzoni and R. Panizzieri, Phys Status Solidi A 91 (1985) K63
[NPTL 3] F. Bolzoni, F. Leccabue, L. Pareti, and J. L. Sanchez, J. Phys (Paris), 46 (1985) C6-305
[NPTL 4] M. Sagawa, S. Hirosawa, H. Yamamoto, S. Fujimura and Y. Matsuura, Jpn. J. Appl. Phys. 26 (1987) 785
[NPTL 5] X. C. Kou, X. K. Sun, Chuang R. Groessinger and H. R. Kirchmayr, J. Magn Magn Mater., 80 (1989) 31

### SUMMARY

### Problems to be Solved

An object of the present disclosure is to improve the magnetic properties of a rare earth permanent magnet comprising a main phase containing Nd, Fe, and B.

### Means to Solve the Problems

One mode of the present disclosure is a rare earth permanent magnet comprising a main phase containing: one or more elements R selected from a group consisting of Nd and Pr; one or more elements L selected from a group consisting of Co, Be, Li, Al and Si; one or more elements A selected from a group consisting of Tb, Sm, Gd, Ho and Er; Fe; and B, wherein crystals forming the main phase belong to P4₂/mnm, and some B atoms occupying a 4f site of the crystals are substituted by atoms of the elements L.

### Advantageous Effects

The present disclosure is able to improve the magnetic properties of a rare earth permanent magnet comprising a main phase containing Nd, Fe, and B.

### BRIEF DESCRIPTION OF DRAWINGS

FIG. 1 is a diagram illustrating a crystal structure model of a main phase according to one embodiment of the present disclosure.

FIG. 2 is a schematic diagram of a fine texture according to one embodiment of the present disclosure.

FIG. 3 is a table showing the composition of the raw material alloys of the Examples of the present disclosure.

FIG. 4 is a diagram showing the measurement results of the magnetic properties of the Examples of the present disclosure.

FIG. 5 is a diagram showing the measurement results of the magnetic properties of the Examples of the present disclosure.

FIG. 6A and FIG. 6B are diagrams showing the results of the Rietveld analysis of the crystal structure of the Examples of the present disclosure.

FIG. 7A to FIG. 7C are diagrams showing the data using the Rietveld refinement of the crystal structure of the Examples of the present disclosure.

FIG. 8 is a diagram showing the data using the Rietveld refinement of the crystal structure of the Examples of the present disclosure.

FIG. 9 is a diagram showing the results of the Rietveld analysis of the crystal structure of the Examples of the present disclosure.

FIG. 10 is a table showing the chemical composition of the raw alloys of the Examples of the present disclosure.

FIG. 11 is a diagram showing the 3DAP analysis results of the crystal structure of the Examples of the present disclosure.

FIG. 12 is a diagram showing the 3DAP analysis results of the crystal structure of the Examples of the present disclosure.

FIG. 13 is a diagram showing the 3DAP analysis results of the crystal structure of the Examples of the present disclosure.

FIG. 14 is a diagram showing the 3DAP analysis results of the crystal structure of the Examples of the present disclosure.

FIG. 15 is a diagram showing the measurements results, based on the Spatial Distribution function, of the crystal structure of the Examples of the present disclosure.

FIG. 16 is a diagram showing the measurements results, based on the Spatial Distribution function, of the crystal structure of the Examples of the present disclosure.

FIG. 17 is a diagram showing the measurement results of the magnetic properties of the Examples of the present disclosure.

FIG. 18 is a diagram showing the measurement results of the magnetic properties of the Examples of the present disclosure.

### DESCRIPTION OF EMBODIMENTS

One mode of the present disclosure comprises a main phase containing: one or more elements R selected from a group consisting of Nd and Pr; one or more elements L selected from a group consisting of Co, Be, Li, Al and Si; one or more elements A selected from a group consisting of Tb, Sm, Gd, Ho and Er; Fe; and B, wherein crystals forming the main phase belong to P4₂/mnm, and some B atoms occupying a 4f site of the crystals are substituted by atoms of the elements L. This mode is able to improve the residual magnetic flux density Br as a result of some predetermined B atoms being substituted by atoms of the elements L.

Moreover, in several modes of the present disclosure, in addition to the B atoms occupying the 4f site, some atoms selected from a group consisting of Nd atoms occupying the 4f site, Fe atoms occupying a 4c site, and Fe atoms occupying a 8j site of the crystals belonging to P4₂/mnm may also be substituted by atoms of the elements L. Even in this kind of mode, it is possible to improve the residual magnetic flux density Br of a rare earth permanent magnet.

Whether some predetermined atoms have been substituted by atoms of the elements L in several modes of the present disclosure can be determined based on Rietveld analysis. In other words, whether or not the substitution occurred can be determined based on the space group of crystals forming the main phase identified from the analysis, and the occupancy rate of the respective elements in the respective sites existing in the space group. However, the present disclosure does not exclude methods other than Rietveld analysis for determining whether predetermined substitution has occurred in the crystal structure of a rare earth permanent magnet.

With regard to the determination of substitution by atoms of the elements L described above, a mode in which B atoms occupying the 4f site of P4₂/mnm are substituted by atoms of the elements L is now explained as an example. The same method may be adopted in determining the substitution of Nd atoms occupying the 4f site, Fe atoms occupying the 4c site, and Fe atoms occupying the 8j site.

The crystals forming the main phase of the present disclosure belong to P4₂/mnm. The occupancy rate of atoms of the elements L in the 4f site occupied by B atoms of the space group is defined as n. When n>0.000, it can be determined that some B atoms occupying the 4f site have been substituted by atoms of the elements L. Note that the occupancy rate of B atoms occupying the 4f site together with atoms of the elements L can be defined as 1.000-n.

So as long as the crystal structure of the main phase is maintained, there is no restriction on the upper limit of the value of the occupancy rate n of atoms of the elements L. With regard to the elements L that substitute B atoms occupying the 4f site, n tends to be calculated within the range of 0.030≦n≦0.100. When expressing the occupancy rate as a percentage, this will be (n×100)%. From the perspective of reliable analysis results, the s value is 1.3 or less, and more preferable as it is closer to 1. Most preferably, the s value is 1. The s value is a value that is obtained by dividing R-weighted pattern (R_{wp}) of reliability factor R by R-expected (Rₑ).

One mode of the present disclosure comprises a main phase containing: one or more elements R selected from a group consisting of Nd and Pr; one or more elements L selected from a group consisting of Co, Be, Li, Al and Si; one or more elements A selected from a group consisting of Tb, Sm, Gd, Ho and Er; Fe; and B. In several modes of the present disclosure, improvement of the residual magnetic flux density Br is particularly notable by including Sm (samarium) and Gd (gadolinium). Moreover, the coercive force H_{cj} can be improved by including Tb (terbium), Ho (holmium), and Er (erbium). Accordingly, when B is substituted by a predetermined element L and the element A is included, it is possible to improve both the residual magnetic flux density Br and the coercive force H_{cj}.

P

There may be cases where the foregoing crystals cyclically include a R—Fe—B layer containing: one or more of the elements R selected from a group consisting of Nd and Pr; Fe; and B, and an Fe layer, some B atoms are substituted by atoms of the elements L, and the R—Fe—B layer contains atoms of the elements A.

The space group P4₂/mnm of the crystals of the main phase has two 16k sites, two 8j sites, one 4g site, two 4f sites, one 4e site, and one 4c site. In the ensuing explanation, when there are multiple sites as with 16k, there may be cases where the sites are indicated as first 16k and second 16k. However, expressions such as “first” and “second” are added for differentiating the sites, and do not characterize the respective sites unless so explained herein.

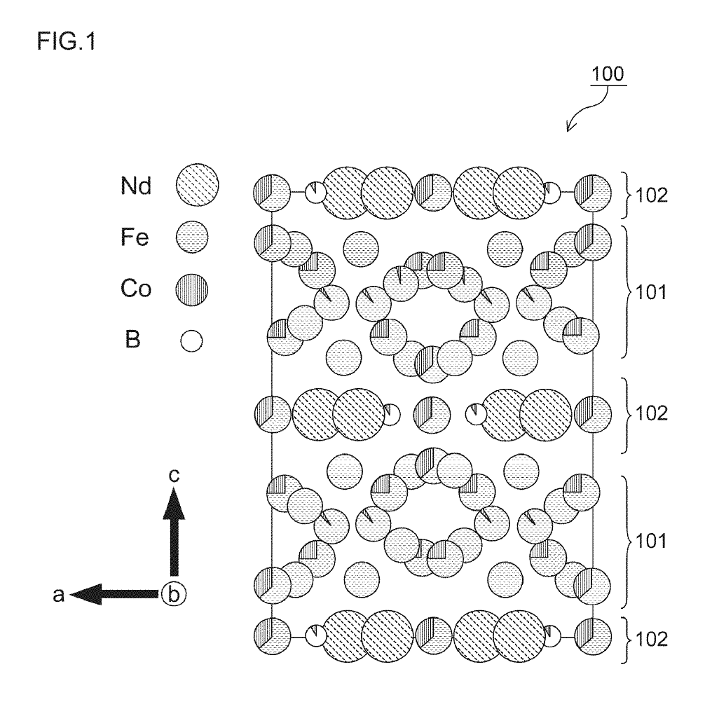

In the foregoing cyclic layer structure, atoms of the elements R occupying the first 4f site and the 4g site, Fe atoms occupying the 4c site, and B atoms occupying the second 4f site form the R—Fe—B layer. Fe atoms occupying the two 16k sites, the two 8j sites and the 4e site form the Fe layer. FIG. 1 shows an example of a crystal structure model of the main phase of a rare earth permanent magnet according to one embodiment of the present disclosure corresponding to the foregoing mode. In FIG. 1, 100 represents the unit cell of the main phase, 101 represents the Fe layer, and 102 represents the R—Fe—B layer. The Fe layer 101 and the R—Fe—B layer 102 exist alternately along the c axis direction. The distance between the two adjacent R—Fe—B layers 102 sandwiching the Fe layer 101 is 0.59 to 0.62 nm. This embodiment adopts the crystal structure model illustrated in FIG. 1 as the basic structure.

Moreover, in this embodiment, some B atoms configuring the basic structure are substituted by the element L (Co in FIG. 1). It is thereby possible to improve the residual magnetic flux density Br. Furthermore, as illustrated in FIG. 1, atoms of the elements L may also be substituted by Fe atoms. Moreover, while not shown, atoms of the elements L may also be substituted by Nd atoms. The number of atoms configuring the unit lattice of the main phase in this embodiment represents 90 to 98 at % of the number of atoms of the particles of the rare earth permanent magnet. Note that, in this embodiment, impurities may be contained in the main phase to the extent that the effects of this embodiment can still be exhibited.

In this embodiment, the magnetic moment of the elements R can be suppressed by reducing the B content. Moreover, based on the reduction of the B content, the foregoing basic structure becomes destabilized, and it becomes easier for other elements to penetrate the basic structure or fill the voids in the basic structure. In a rare earth permanent magnet containing C as another element, B tends to become substituted by C when the basic structure is destabilized.

Nevertheless, unlike the foregoing rare earth permanent magnet, this embodiment does not contain C, or the C content is an extremely trace amount. Consequently, B is substituted by the element L, and is not substituted by C. Moreover, even in cases where it is acknowledged that B has been substituted by C, the part that is substituted by C is small in comparison to the part that is substituted by the element L.

In this embodiment, the B content is suppressed in order to obtain a crystal structure in which B is substituted by the element L, and the C content is controlled so that C does not penetrate the crystal structure of the main phase. For example, the predetermined crystal structure of this embodiment can be obtained by preventing, to the extent possible, C sources such as paper, plastic and oil from coming into contact with the raw material alloy in the production process.

As an example of subjecting the raw material alloy of this embodiment to elemental analysis in the case of controlling the C content according to the method illustrated above, there is a case where the B content is 0.94% and the C content is 0.03% in the raw material alloy, and the B content is 0.94% and the C content is 0.074% in the rare earth permanent magnet of this embodiment obtained by sintering the foregoing raw material alloy. As another example, there is a case where the B content is 0.86% and the C content is 0.009% in the raw material alloy, and the B content is 0.86% and the C content is 0.059% in the rare earth permanent magnet of this embodiment obtained by sintering the foregoing raw material alloy. Note that the foregoing elemental analysis was performed using ICP Emission Spectroscopy ICPS-8100 manufactured by Shimadzu Corporation. The foregoing unit (%) represents wt %.

Moreover, excluding the grain boundary part of the two rare earth permanent magnets illustrated above, the center part in the particles; that is, the main phase part was analyzed using a 3-dimensional atom probe (3DAP). LEAP3000XSi manufactured by AMETEK was used for this analysis, and the measurement conditions were set as follows: laser pulse mode (laser wavelength=532 nm), laser power=0.5 nJ, and sample temperature=50 K. In both cases, the C content in the main phase was equal to or less than the detection limit of 0.02%. Consequently, in this embodiment, even in cases where C is contained, it has been confirmed that most of C exists in the grain boundary phase, and the main phase contains C only in an amount that is equivalent to unavoidable impurities. While C was analyzed in the foregoing example, the same mode as C may result for N and O.

The element R is Nd, and a part of Nd may be substituted by Pr. The atomic ratio of Nd and Pr is 80:20 to 70:30. From the perspective of cost reduction, preferably, the ratio of Pr is large and the ratio of Nd is small. Nevertheless, when the ratio of Nd becomes smaller than 70 in the foregoing atomic ratio, the possibility of deterioration of the residual magnetic flux density Br will increase. Note that, in this embodiment, the element L may also be substituted by Nd and Fe.

In this embodiment, a part of B is substituted by one or more elements L selected from a group consisting of Co, Be Li, Al and Si. This embodiment is thereby able to improve the residual magnetic flux density Br of the rare earth permanent magnet. The element L is preferably Co. In addition to the elements illustrated above, B may also be substituted by elements having a wave function suitable for interstice, and elements having an atomic radius that is smaller than the atomic radius of B.

The atomic ratio of B and the element L (B:element L) is expressed as (1-x):x, and x satisfies 0.01≦x≦0.25, and 0.03≦x≦0.25 is preferable. When x<0.01, the magnetic moment will deteriorate. When x>0.25, a predetermined crystal structure cannot be maintained.

In this embodiment, the electron donors from Nd atoms to B atoms can be reduced as a result of B being substituted by a predetermined element. Consequently, it is possible to suppress the reduction in the number of unpaired electrons of Nd, and consequently improve the magnetic moment of Nd atoms. Note that, in this embodiment, the element L may also be substituted by Nd and Fe.

The magnetic moment of Nd atoms configuring the main phase of this embodiment is greater than the magnetic moment of Nd atoms in a Nd₂Fe₁₄B crystal. This magnetic moment is at least greater than 2.70μPB, and preferably 3.75 to 3.85μ_{PB}, and more preferably 3.80 to 3.85μ_{PB}.

Otherwise, in this embodiment, the R—Fe—B layer 102 contains one or more elements A selected from a group consisting of Tb, Sm, Gd, Ho and Er. The residual magnetic flux density Br can be increased by including Sm and Gd. Moreover, the coercive force H_{cj} can be improved by including Tb, Ho and Er. As a result of concurrently using the respective elements described above, it is possible to improve both the coercive force H_{cj} and the residual magnetic flux density Br. Note that, in this embodiment, the element A may also be substituted by Fe.

This embodiment covers a mode where non-substituted elements L and elements A, which were not substituted by any one of the elements R, Fe and B, and other elements contained in the raw material alloy, exist in any one of the sites of the Nd—Fe—B layer. As examples of other elements, considered may be known elements that improve the magnetic properties of a rare earth permanent magnet. Moreover, in certain cases elements such as Cu, Nb, Zr, Ti, and Ga that form a grain boundary phase and elements such as O that form a sub phase may penetrate one of the sites of the crystal structure of the main phase.

In this embodiment, because the magnetism of Nd atoms is expressed, magnetic properties that are more favorable than the magnetism deriving from Fe atoms and Nd atoms are exhibited. The magnetic properties of this embodiment can be evaluated based on the coercive force H_{cj} and the residual magnetic flux density Br. The magnetic properties of this embodiment are improved by roughly 40 to 50% in comparison to a conventional rare earth permanent magnet formed from Nd₂Fe₁₄B crystals due to the increase in the number of unpaired electrons. In particular, a favorable residual magnetic flux density Br can be yielded by adding the element A.

The rare earth permanent magnet of this embodiment comprises a grain boundary phase formed between a main phase and a main phase, and the content of the elements R relative to the total weight of the rare earth permanent magnet is 20 to 35 wt %, and preferably 22 to 33 wt %. When using Nd and Pr as the elements R, Nd is preferably 15 to 40 wt %, and Pr is preferably 5 to 20 wt %. The B content is 0.80 to 0.99 wt %, and preferably 0.82 to 0.98 wt %. The total content of one of more elements selected from a group consisting of Co, Be, Li, Al, Si, Cu, Nb, Zr, Ti and Ga is 0.8 to 2.0 wt %, and preferably 0.8 to 1.5 wt %. The total content of one or more elements A selected from a group consisting of Tb, Sm, Gd, Ho and Er is 2.0 to 10.0 wt %, and preferably 2.6 to 5.4 wt %. The remainder is iron. As a result of the respective components having the foregoing contents, this embodiment can achieve the predetermined crystal structure described above. It is thereby possible to obtain a favorable residual magnetic flux density Br and coercive force H_{cj}.

In addition to comprising the foregoing main phase, this embodiment preferably comprises a grain boundary phase between the main phases. The grain boundary phase formed between the main phases preferably contains one or more elements selected from a group consisting of Al, Cu, Nb, Zr, Ti and Ga.

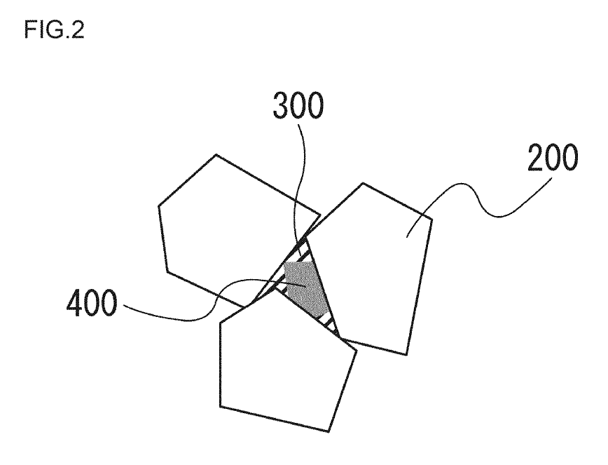

FIG. 2 is a schematic diagram showing an example of a fine texture according to one embodiment of the present disclosure. In FIG. 2, 200 represents the main phase, 300 represents the grain boundary phase, and 400 represents the sub phase. When a magnetic field is applied to the rare earth permanent magnet comprising the fine texture illustrated in FIG. 2, the spin electrons of the grain boundary phase components pin the spin electrons of the main phase components, and the inverse spinning of the main phase components is inhibited. In other words, the grain boundary phase cuts the magnetic exchange coupling of the main phase. It is thereby possible to improve the coercive force H_{cj}.

When the grain boundary phase components of this embodiment are Al and Cu, the content of Al relative to the total weight of the rare earth permanent magnet is preferably 0.1 to 0.4 wt %, and more preferably 0.2 to 0.3 wt %. The Cu content is preferably 0.01 to 0.1 wt %, and more preferably 0.02 to 0.09 wt %. When Zr is added, the Zr content is preferably 0.004 to 0.04 wt %, and more preferably 0.01 to 0.04 wt %.

This embodiment is able to exhibit a high residual magnetic flux density Br, a high coercive force H_{cj}, and a large maximum energy product BHₘₐₓ. Moreover, the magnetic properties can be further improved by refining the sintered particle size of the sintered particles including the main phase. Moreover, when Ho or the like is included as the element A, superior heat resistance is also exhibited.

The rare earth permanent magnet of this embodiment can be produced by using the sintered particles obtained by performing heat treatment to a powder of a raw material alloy of the rare earth permanent magnet. This kind of raw material alloy contains: the element R; one or more elements selected from a group consisting of Co, Be, Li, Al, Si, Cu, Nb, Zr, Ti and Ga; the element A; Fe; and B, the powder particle size D₅₀ is 2 to 18 μm, preferably 2 to 13 μm, and more preferably 2 to 9 μm. When the powder particle size deviates from the foregoing preferred ranges, it becomes difficult to obtain a rare earth permanent magnet comprising a favorable sintered particle size.

In this embodiment, “powder particle size” means the particle size of the raw material alloy in powder form or particle form before the heat treatment process. The powder particle size can be measured based on known methods using a laser diffraction-type particle size distribution measuring device. Moreover, “sintered particle size” means the particle size of the raw material alloy in powder form or particle form after the heat treatment process. In this embodiment, D₅₀ refers to the median diameter in the cumulative distribution of the alloy fine particle group on a volumetric basis.

The sintered particle size D₅₀ of the rare earth permanent magnet of this embodiment is preferably 2.2 to 20 μm, more preferably 2.2 to 15 μm, and most preferably 2.2 to 10 μm. When the sintered particle size D₅₀ exceeds 20 μm, the coercive force will deteriorate considerably.

The sintered particle size obtained by subjecting the foregoing raw material alloy to heat treatment is 110 to 300% of the powder particle size, and more specifically 110 to 180%. Accordingly, as a result of adjusting the powder particle size to be within a predetermined range by pulverizing the raw material alloy using a known means such as a ball mill or a jet mill, and subjecting the pulverized raw material alloy to processes such as molding, magnetization, degreasing, and heat treatment, it is possible to obtain the sintered particles comprising a sintered particle size within the foregoing favorable range.

The sintered density of the rare earth permanent magnet of this embodiment is preferably 6.0 to 8.0 g/cm³. In this embodiment, the higher the sintered density, the greater the residual magnetic flux density Br. Thus, the sintered density is preferably as high as possible beyond 6.0 g/cm³. However, the sintered density of this embodiment is determined based on the powder particle size of the raw material alloy, and based on the treatment temperature, sintering temperature and aging temperature adopted in the heat treatment processes described later.

Accordingly, depending on the raw material alloy that can be prepared and the conditions of the heat treatment process, the sintered density will be 6.0 to 8.0 g/cm³, preferably 7.0 to 7.9 g/cm³, and more preferably 7.2 to 7.7 g/cm³. When the sintered density is lower than 6.0 g/cm³, the number of voids in the sintered body will increase and cause the residual magnetic flux density Br and the coercive force H_{cj} to deteriorate, and it will not be possible to obtain the rare earth permanent magnet comprising the predetermined magnetic properties of this embodiment.

[Production Method of Rare Earth Permanent Magnet]

There is no particular limitation in the method of producing the rare earth permanent magnet of this embodiment so as long as the effects of this embodiment can be exhibited. As a preferred production method of this embodiment, considered may be the production method including a pulverization process, a magnetization process, a degreasing process, and a heat treatment process. The product obtained based on each of the foregoing processes is cooled to room temperature based on a cooling process, and the rare earth permanent magnet of this embodiment can thereby be produced.

[Pulverization Process]

In the pulverization process, one or more elements R selected from a group consisting of Nd and Pr; one or more elements selected from a group consisting of Co, Be, Li, Al, Si, Cu, Nb, Zr, Ti and Ga; one or more elements A selected from a group consisting of Tb, Sm, Gd, Ho and Er; Fe; and B, are melted at the stoichiometric ratio described above to obtain a raw material alloy.

The stoichiometric ratio at which the raw material alloy is blended is basically the same as the composition of the compound, as the end product, to become the main phase of this embodiment. Accordingly, the raw material may be blended according to the intended composition of the compound. Note that, even when including elements such as Dy that differ from the elements illustrated above, such elements are blended together with the foregoing raw material. Note that, desirably, this raw material alloy is not an amorphous alloy.

The obtained raw material alloy is crushed using a ball mill or a jet mill. The powder particle size D₅₀ is preferably 2 to 25 μm, and more preferably 2 to 18 μm. The powder particle size D₅₀ is most preferably 2 to 15 μm or 2 to 13 μm. Subsequently, the crushed raw material alloy fine particles are preferably further pulverized using a ball mill or a jet mill.

The crushed raw material alloy particles are dispersed in an organic solvent, and a reducing agent is added thereto. For example, with the total content of Tb, Sm, Gd, Ho and Er as 100% upon producing the rare earth permanent magnet of this embodiment by using a raw material alloy having a powder particle size D₅₀ of 2 to 18 μm, even when the content of Tb, Sm, Gd, Ho and Er is decreased by 20 to 30%, the same level of magnetic properties when the foregoing content is 100% can be exhibited.

[Magnetization Process]

In the magnetization process, the obtained raw material alloy fine particles are subject to compression molding in an orientation magnetic field. The obtained compact is additionally sintered in a vacuum in the heat treatment process, and the sintered material is thereafter cooled to room temperature. Subsequently, the sintered material is subject to aging treatment in an inert gas atmosphere, and then cooled to room temperature.

In this embodiment, a degreasing process is preferably provided before the heat treatment process. As a result of performing the degreasing process, it is possible to suppress the substitution of B by C even in cases where the raw material alloy contains trace amounts of C.

[Heat Treatment Process]

In the heat treatment process, the main phase and the grain boundary phase are formed based on predetermined temperature management and time management. The heat treatment conditions are decided based on the melting points of the contained components. In other words, all contained components are melted by raising the treatment temperature to the main phase forming temperature and maintaining such temperature. Subsequently, the main phase components become a solid phase during the process of lowering the temperature from the main phase forming temperature to the grain boundary phase forming temperature, and the grain boundary phase components start to become precipitated on the solid phase surface. The grain boundary phase can be formed by maintaining the grain boundary phase forming temperature.

In this embodiment, adopted is a method of producing a rare earth permanent magnet including a heat treatment step of retaining, at a first treatment temperature, a raw material alloy containing: one or more elements R selected from a group consisting of Nd and Pr; one or more elements selected from a group consisting of Co, Be, Li, Al, Si, Cu, Nb, Zr, Ti and Ga; one or more elements A selected from a group consisting of Tb, Sm, Gd, Ho and Er; Fe; and B, wherein the rare earth permanent magnet comprises a main phase containing: the elements R, one or more elements L selected from a group consisting of Co, Be, Li, Al and Si; the elements A; Fe; and B, crystals forming the main phase belong to P4₂/mnm, and some B atoms occupying a 4f site of the crystals are substituted by atoms of the elements L.

To put it differently, this embodiment adopts a method of producing a rare earth permanent magnet including a heat treatment step of retaining, at a first treatment temperature, a raw material alloy containing: one or more elements R selected from a group consisting of Nd and Pr; one or more elements selected from a group consisting of Co, Be, Li, Al, Si, Cu, Nb, Zr, Ti and Ga; one or more elements A selected from a group consisting of Tb, Sm, Gd, Ho and Er; Fe; and B, wherein the method forms a main phase which cyclically includes a R—Fe—B layer containing the elements R, Fe, and B, and an Fe layer, and in which some B atoms are substituted by atoms of one or more elements L selected from a group consisting of Co, Be, Li, Al and Si, and the R—Fe—B layer contains atoms of the elements A.

The production method of a rare earth permanent magnet of this embodiment preferably includes a heat treatment step of lowering the treatment temperature to a second treatment temperature after a holding time of the first treatment temperature elapses, and retaining the raw material alloy at the second treatment temperature, wherein the method forms a grain boundary phase between the main phases. In other words, the heat treatment process of this embodiment includes a sintering process, and may also include an aging process.

In the heat treatment process, the raw material alloy particles are foremost heated up to the first treatment temperature, and retained at such temperature until all contained components are melted. This stage in the heat treatment process is the sintering process of this embodiment, and the first treatment temperature may also be referred to as the sintering temperature. The first treatment temperature is set by giving consideration to the melting points of the elements R, Fe, B, the elements L, the elements M, and the elements A contained in the raw material alloy particles.

For instance, the first treatment temperature is preferably 1000 to 1200° C., and more preferably 1010 to 1090° C. As a specific example, when Nd and Pr are selected as the elements R, Co is selected as the element L, and Tb and Sm are selected as the elements A, the first treatment temperature can be set to 1030 to 1080° C. When Nd and Pr are selected as the elements R, Co is selected as the element L, and Tb and Ho are selected as the elements A, the first treatment temperature can be set to 1030 to 1060° C.

After the sintering process, the heat treatment process proceeds to the aging process. In the aging process, the main phase components containing at least the elements R, Fe, B, the elements L and the elements A form a solid phase and the grain boundary phase components start to become precipitated on the solid phase surface in the course of lowering the temperature from the first treatment temperature to the second treatment temperature. In this embodiment, with regard to the one or more elements selected from a group consisting of Al, Cu, Nb, Zr and Ti, some parts of these elements form a solid phase together with other main phase components, and the other parts of these components become precipitated on the solid phase surface and form a grain boundary phase. By retaining the second treatment temperature, it is possible to form a grain boundary phase, and a main phase containing elements that are common with the grain boundary phase components.

The second treatment temperature is set based on the grain boundary phase forming temperature. In the aging process, temperature management is performed in one or more stages. Accordingly, when performing n-stage temperature management, the second treatment temperature is changed in stages from the first aging temperature up to the n-th aging temperature, and then retained at such temperature.

The rare earth permanent magnet of this embodiment can be produced by performing the respective processes described above. This rare earth permanent magnet comprises a main phase containing: one or more elements R selected from a group consisting of Nd and Pr; one or more elements L selected from a group consisting of Co, Be, Li, Al and Si; one or more elements A selected from a group consisting of Tb, Sm, Gd, Ho and Er; Fe; and B, wherein crystals forming the main phase belong to P4₂/mnm, and, in the least, some B atoms occupying a 4f site of the crystals are substituted by atoms of the elements L. Moreover, depending on the raw material and the treatment temperature, some atoms selected from a group consisting of Nd atoms occupying the 4f site, Fe atoms occupying a 4c site, and Fe atoms occupying a 8j site of the crystals belonging to P4₂/mnm may be substituted by atoms of the elements L.

The rare earth permanent magnet obtained based on the respective processes described above forms a main phase cyclically include a R—Fe—B layer containing the elements R, Fe, and B, and an Fe layer, some B atoms are substituted by atoms of the elements L, and one or more elements selected from the elements R, Fe and B contain one or more elements A selected from a group consisting of Tb, Sm, Gd, Ho and Er, and comprises a grain boundary phase between the main phases.

Moreover, the sintered particle size of the crystals of the rare earth permanent magnet obtained based on the heat treatment process is 110 to 300% of the powder particle size, and more specifically 110 to 180%. Accordingly, the sintered particle size D₅₀ is preferably 2.2 to 20 μm, more preferably 2.2 to 15 μm, and most preferably 2.2 to 10 μm.

The rare earth permanent magnet of this embodiment obtained based on the respective processes described above has a sintered density of 6.0 to 8.0 g/cm³, and more preferably 7.2 to 7.9 g/cm³.

### EXAMPLES

This embodiment is now explained in further detail with reference to the following Examples. However, this embodiment is not limited by the following Examples.

### Example 1, Example 2, Comparative Example 1

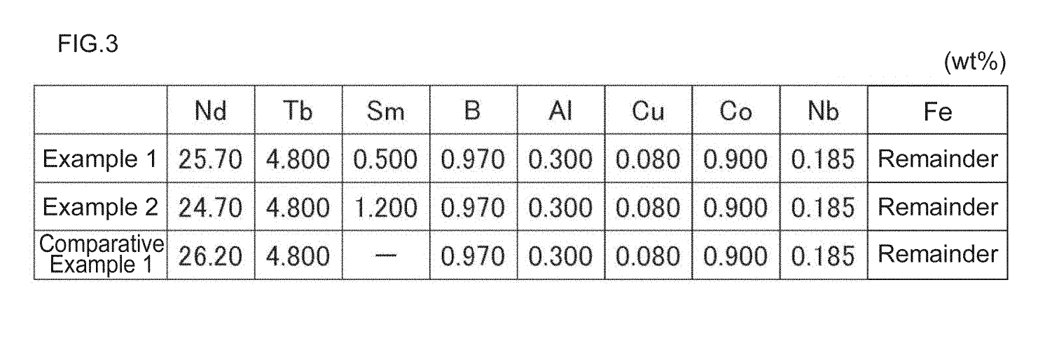

A raw material alloy containing the respective elements in the composition shown in FIG. 3 was crushed with a ball mill to obtain alloy particles. The alloy particles were subsequently dispersed in a solvent. An additive was placed in the dispersed solution, the dispersed solution was agitated to perform reduction reaction, and the alloy particles were thereby pulverized.

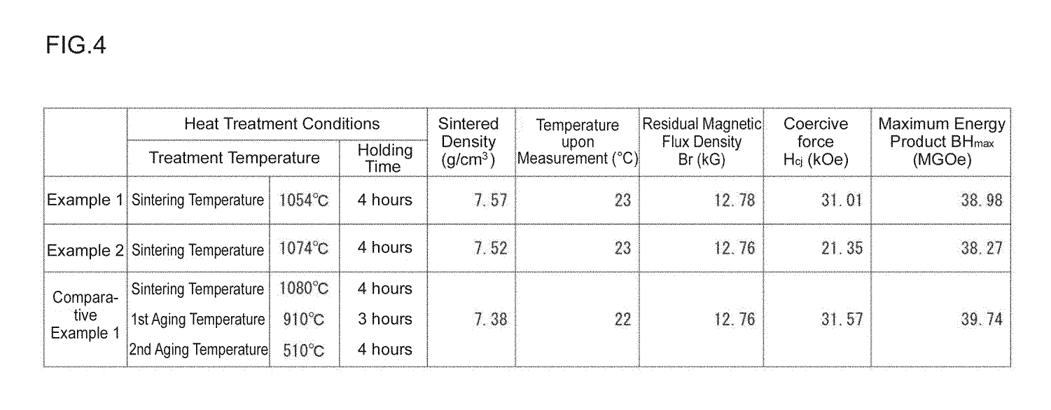

The pulverized raw material alloys were respectively filled in a molding cavity and subject to compression molding at a molding pressure of 2 t/cm² upon applying a magnetic field of 19 kOe, and further subject to magnetization and degreasing. The obtained compacts were subject to a heat treatment process in a vacuum condition of 2×10¹ Torr under the heat treatment conditions shown in FIG. 4. After the completion of the heat treatment process, the compacts were cooled to room temperature and then removed from the cavity to obtain the rare earth permanent magnets of Example 1 and Example 2. Example 1 and Example 2 are magnets in a state where the main phase was formed, but the grain boundary phase has not been completely formed.

### Comparative Example 1

The alloy of Comparative Example 1 was obtained from the raw material alloy containing the respective elements in the composition shown in FIG. 3 by using a rapid solidification device. Table 1 shows the analytical values of the center point of the alloy of Comparative Example 1 based on ICP emission spectrometry.

TABLE 1
(wt %)

| | Nd | Tb | Sm | B | Al | Cu | Co | Nb | Fe |
|---|---|---|---|---|---|---|---|---|---|
| Comparative | 25.768 | 4.368 | — | 0.967 | 0.382 | 0.090 | 0.850 | 0.180 | Remainder |
| Example 1 | | | | | | | | | |

Subsequently, the alloy was dispersed in a solvent, an additive was placed in the dispersed solution, the dispersed solution was agitated to perform reduction reaction, and the alloy was thereby pulverized. The powder particle size D₅₀ of the obtained alloy fine powder was 3 to 11 μm. The powder particle size was measured using a permissible substitute of the laser diffraction-type particle size distribution measuring device SALD-2300 manufactured by Shimadzu Corporation.

The pulverized raw material alloy was filled in a molding cavity and subject to compression molding at a molding pressure of 2 t/cm² upon applying a magnetic field of 19 kOe, and further subject to magnetization. The obtained compact was subject to a heat treatment process in a vacuum condition of 2×10¹ Torr under the heat treatment conditions shown in FIG. 4. After the completion of the heat treatment process, the compact was cooled to room temperature and then removed from the cavity to obtain the rare earth permanent magnet of Comparative Example 1. Comparative Example 1 is a magnet in a state where the main phase and the grain boundary phase were formed.

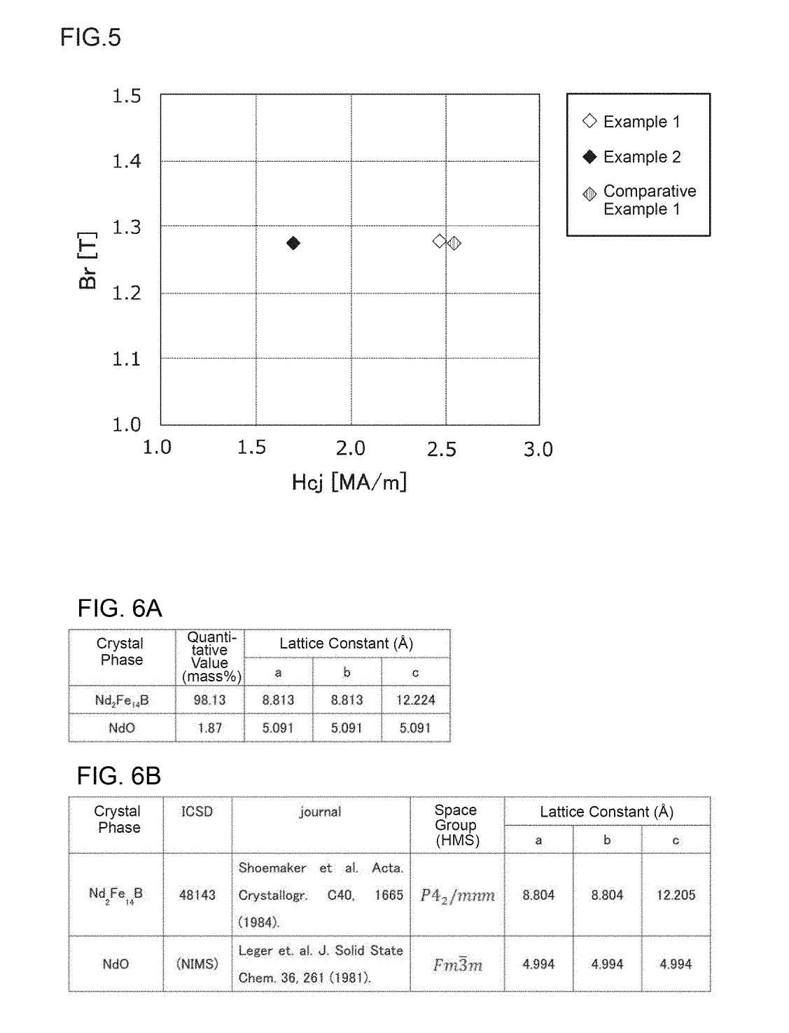

The magnetic properties of the rare earth permanent magnets of Example 1, Example 2 and Comparative Example 1 were measured using a permissible substitute of the TPM-2-08S pulse excitation-type magnet measuring device (with a sample temperature variable device) manufactured by Toei Industry Co., Ltd. The measurement results are shown in FIG. 4 and FIG. 5. Note that, in FIG. 5, the unit [kG] of the residual magnetic flux density Br shown in FIG. 4 was converted into [T]. Moreover, the unit [kOe] of the coercive force H_{cj} was converted into [MA/m].

In order to more precisely analyze the crystal structure of Example 2, X-ray diffraction testing and Rietveld analysis were performed. In performing the analysis, the existence of a Nd₂Fe₁₄B phase, and NdO as one sub phase component, which are notably observed in the crystals, was assumed. Sm, Tb and other components contained in Example 2 were not given consideration in this analysis. The analyzing device and the analyzing conditions used in the analysis are indicated below. RIETAN-FP was used as the analyzing software.

Analyzing device: Horizontal X-ray diffraction device SmartLab manufactured by Rigaku Corporation

Analyzing conditions:

Target: Cu

Monochromatization: Symmetrical Johansson-type Ge crystals were used on the incident side (CuKα1)

Target output: 45 kV-200 mA

Detector: One-dimensional detector (HyPix3000)

(Normal measurement): θ/2θ scan

Slit incidence: Diffusion ½°

Slit optics: 20 mm

Scan rate: 1°/min

Sampling width: 0.01°

Measured angle (2θ): 10° to 110°

The lattice constant of Example 2 obtained as a result of the analysis is shown in FIG. 6A and FIG. 6B shows the referenced ICSD and literature data. Based on the analysis data shown in FIG. 6A and FIG. 6B, it was possible to identify that the crystals of the main phase of this embodiment belong to P4₂/mnm.

Subsequently, the fitting of the X-ray diffraction pattern of Example 2 and a model pattern was performed. A “model pattern” is a pattern obtained by combining the calculation results of the X-ray diffraction patterns of a NdO crystal and an arbitrary Nd₂Fe₁₄B crystal. An “arbitrary Nd₂Fe₁₄B crystal” refers to a crystal based on the simulation of changing an arbitrary crystal parameter of a known Nd₂Fe₁₄B crystal and substituting atoms occupying one arbitrary site existing in the space group by atoms of the element L (Co in Example 2). s value was used as the fitting index, and the analysis was performed so that s value becomes a value that is approximate to 1. s value is defined as s=R_{wp}/Rₑ.

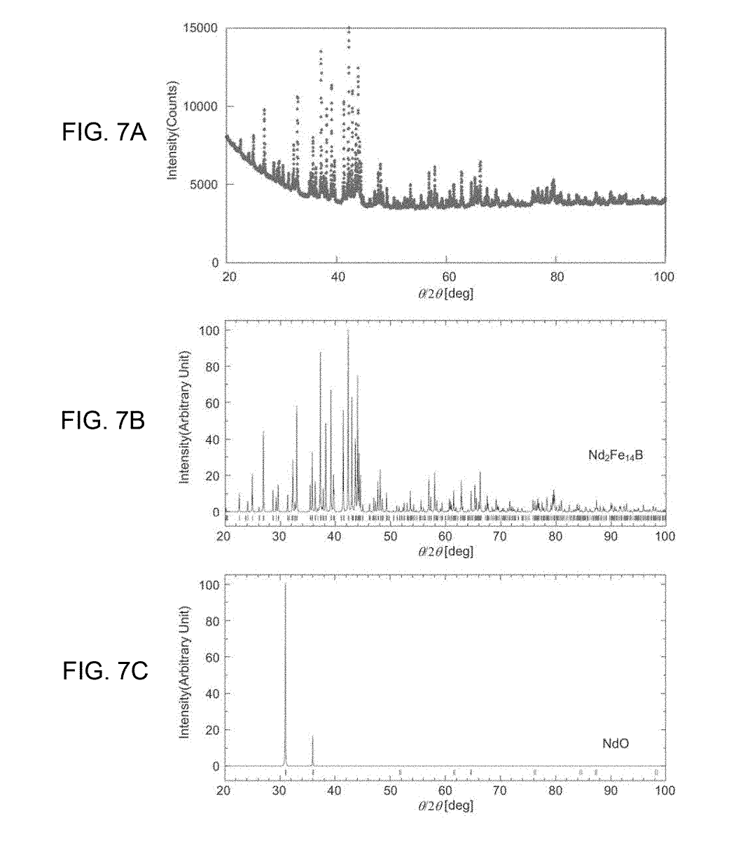

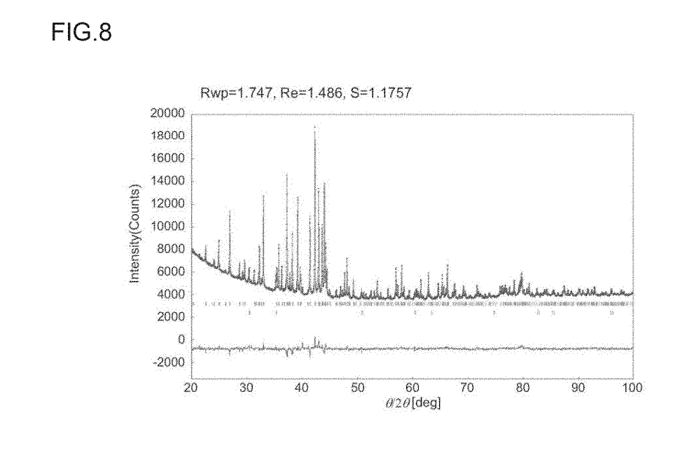

FIG. 7A shows the X-ray diffraction pattern of Example 2. FIG. 7B shows an example of the model pattern of Nd₂Fe₁₄B. FIG. 7C shows an example of the model pattern of NdO. FIG. 8 shows the fitting results of FIG. 7A, FIG. 7B and FIG. 7C. The R factors and s value in the comparison shown in FIG. 8 were respectively R_{wp}=1.747, Rₑ=1.486, and s=1.1757.

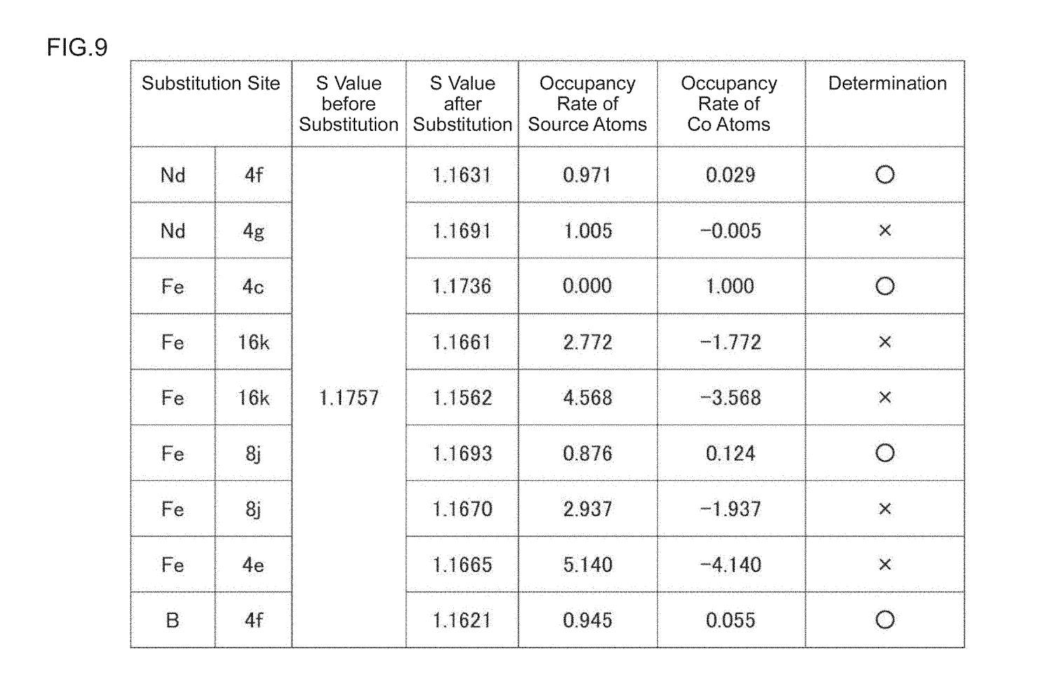

In order to obtain a model that fits FIG. 7A (model with a small s value) better than the model patterns of FIG. 7B and FIG. 7C, a plurality of model patterns were analyzing using Nd₂Fe₁₄B crystals in which atoms of one arbitrary site were substituted by atoms of the element L. FIG. 9 shows the s value in the respective model patterns and the occupancy rate of the atoms based on the analysis results of patterns that fit well among the foregoing plurality of model patterns. In the “Determination” of FIG. 9, “∘” means that atoms occupying the site have been substituted by atoms of the element L (Co atoms in FIG. 9), and “×” means that atoms occupying the site have not been substituted by atoms of the element L (Co atoms in FIG. 9).

As shown in FIG. 9, the occupancy rate of Co atoms in the respective sites was 0.055 in the 4f site occupied by B atoms, 0.029 in the 4f site occupied by Nd atoms, 1.000 in the 4c site occupied by Fe atoms, and 0.124 in the 8j site occupied by Fe atoms. In other words, the occupancy rate of Co atoms in the respective sites exceeds 0.

In other words, the crystals of Example 2 are the Nd₂Fe₁₄B crystals belonging to P4₂/mnm, and Co atoms exist respectively in the first 4f site occupied by B, the second 4f site occupied by Nd, and the 4c site and the first 8j site respectively occupied by Fe. In other words, it was confirmed that some B atoms of the first 4f site, some Nd atoms of the second 4f site, some Fe atoms of the 4c site, and some Fe atoms of the first 8j site have been substituted by Co atoms. Meanwhile, because the occupancy rate of Co atoms was 0 in the 4g site occupied by Nd, the first and second 16k sites occupied by Fe, the second 8j site occupied by Fe, and the 4e site occupied by Fe, it was confirmed that the atoms existing in these sites have not been substituted by Co atoms.

### Example 3 to Example 5, and Comparative Example 2

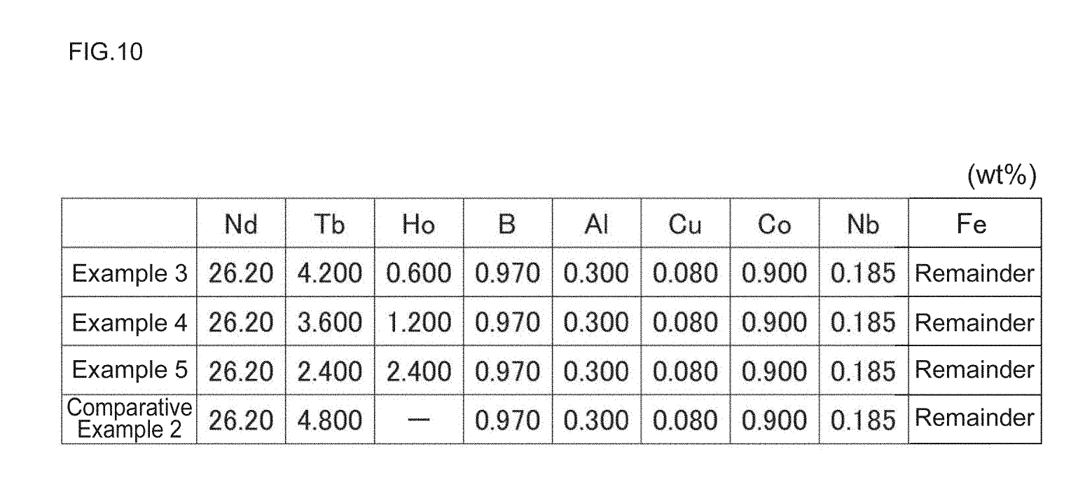

A raw material alloy containing the respective elements in the composition shown in FIG. 10 was crushed with a ball mill to obtain alloy particles. The alloy particles were subsequently dispersed in a solvent. An additive was placed in the dispersed solution, the dispersed solution was agitated to perform reduction reaction, and the alloy particles were thereby pulverized.

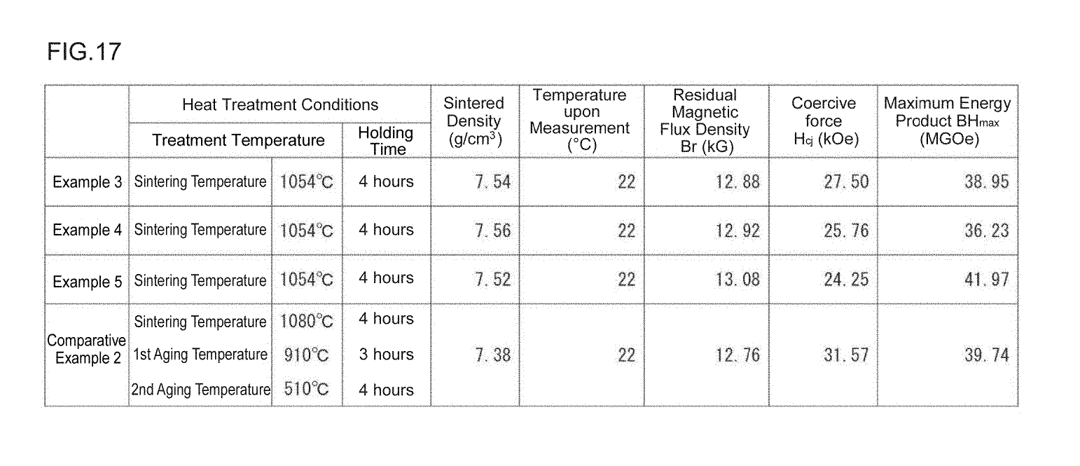

The pulverized raw material alloys were respectively filled in a molding cavity and subject to compression molding at a molding pressure of 2 t/cm² upon applying a magnetic field of 19 kOe, and further subject to magnetization and degreasing. The obtained compacts were subject to a heat treatment process in a vacuum condition of 2×10¹ Torr under the heat treatment conditions shown in FIG. 17. After the completion of the heat treatment process, the compacts were cooled to room temperature and then removed from the cavity to obtain the rare earth permanent magnets of Example 3 to Example 5. Example 3 to Example 5 are magnets in a state where the main phase was formed, but the grain boundary phase has not been completely formed.

[3DAP Crystal Structure Analysis]

In order to observe the crystal structure of the main phase of the rare earth permanent magnet of Example 3 and Example 5, needles to be used as samples in 3DAP analysis were prepared based on the following method. Foremost, the samples of the Examples were set in an Focused Ion Beam (FIB) device, and grooves were formed for observing the surface including the easy direction of magnetization. The surface including the easy direction of magnetization of the samples that appeared as a result of forming the grooves was irradiated with electron beams. The main phase (intraparticle phase) was identified by observing, with an SEM, the reflected electron beams that are emitted from the samples as a result of the foregoing irradiation. The identified main phase was processed into needle shapes for analysis via 3DAP.

The conditions of 3DAP-based crystal structure analysis were as follows.

Device: LEAP3000XSi (manufactured by AMETEK)

Measurement conditions: Laser pulse mode (laser wavelength=532 nm)

Laser power=0.5 nJ

Sample temperature=50 K

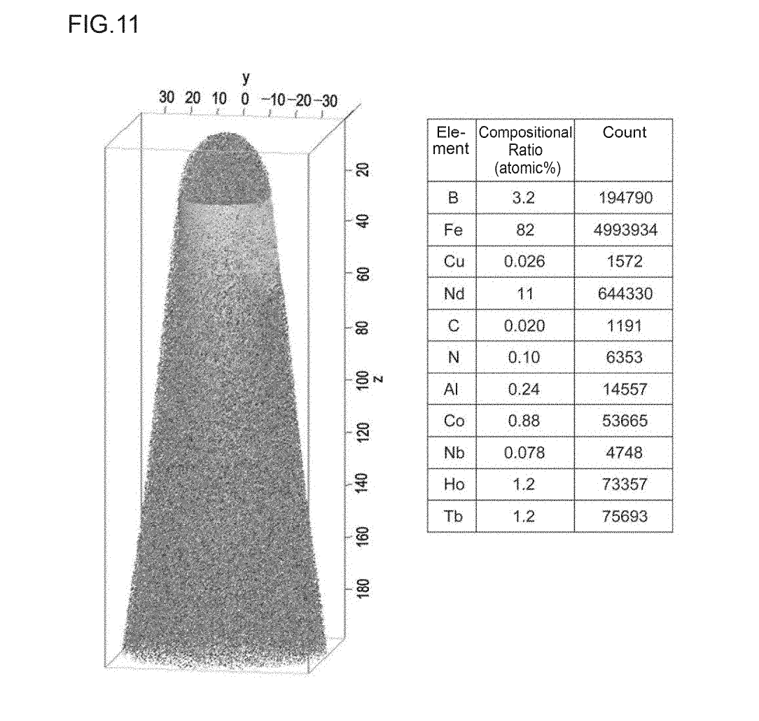

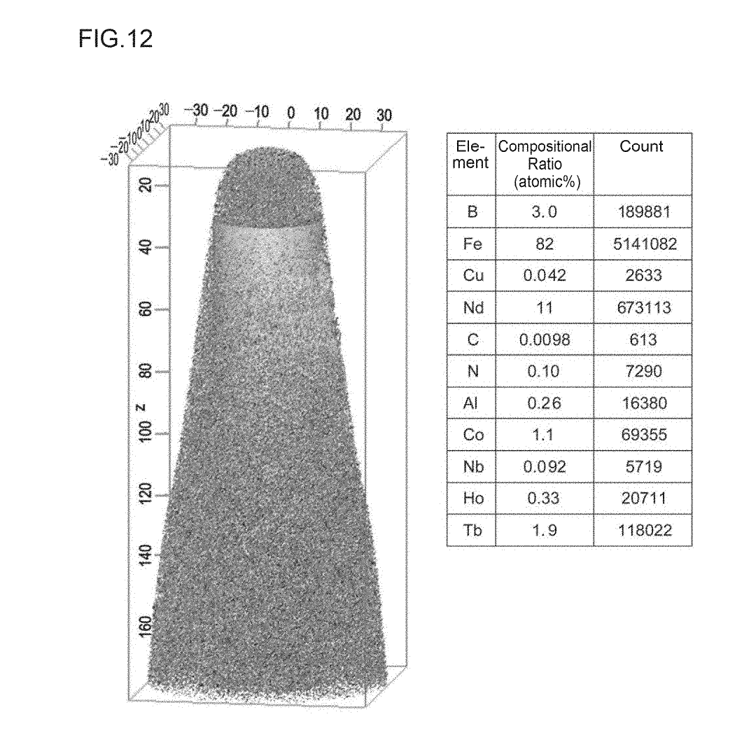

As a result of analyzing the respective needles via 3DAP, a lattice plane of Nd[100] was detected in all cases. The distance between layers was 0.59 to 0.62 nm. FIG. 11 and FIG. 12 show the 3D atomic image obtained via 3DAP and the compositional ratio thereof. FIG. 11 shows the analysis results of the needles of Example 5. FIG. 12 shows the analysis results of the needles of Example 3. As shown in FIG. 11 and FIG. 12, in this embodiment, it is evident that the content of carbon is considerably low in the main phase.

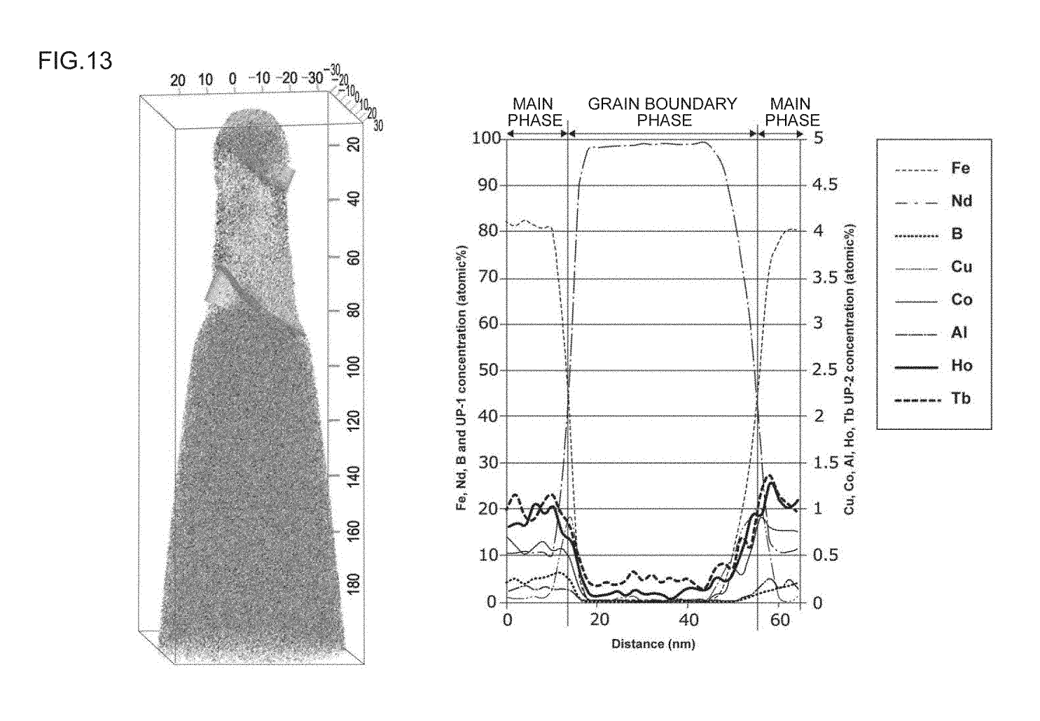

Furthermore, with regard to Example 5, the grain boundary phase profile was also analyzed via 3DAP. FIG. 13 shows the 3D atomic image including the grain boundary phase of Example 5 and the analysis results of the grain boundary phase profile. As shown in FIG. 13, a Nd₂Fe₁₄B phase was observed in the main phase of Example 5, and Tb and Ho were observed as the elements A, and Co and Al were observed as the elements L. The grain boundary phase was a Nd-rich phase. Moreover, Cu had precipitated at the interface of the main phase and the grain boundary phase.

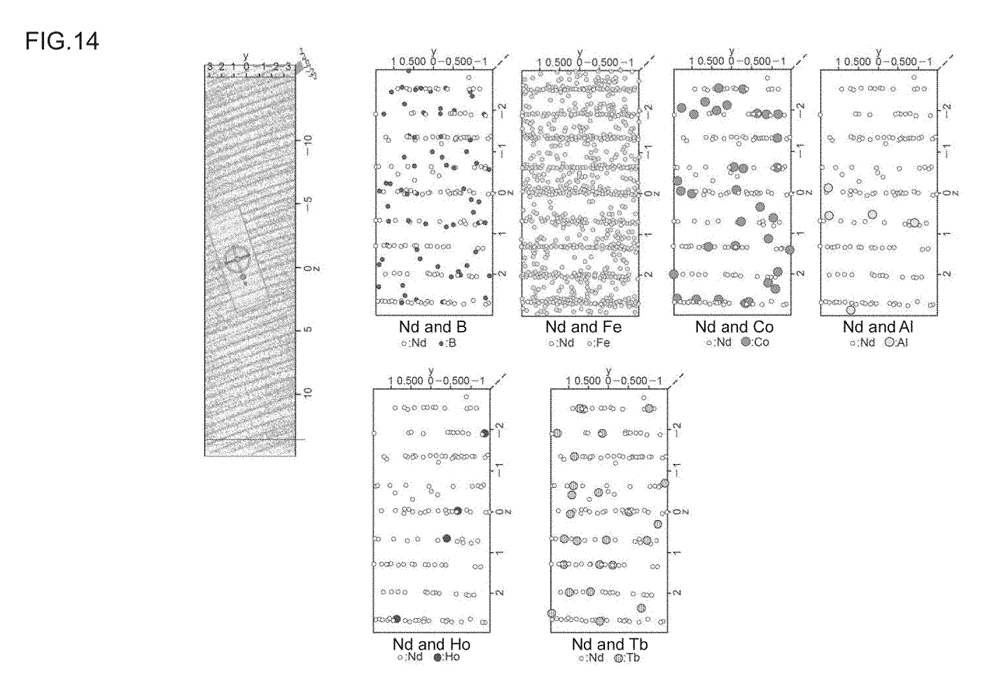

Moreover, with regard to Example 3 and Example 5, the distributions of B, Fe, Co, Al, Ho, and Tb in the Nd—Fe—B layer were analyzed. FIG. 14 shows the analysis results of Example 3. The respective diagrams in FIG. 14 are diagrams respectively displaying a specific element, and the displayed element is indicated below each diagram. In each of these diagrams, a white circle (∘) represents Nd. The element (one element among B, Fe, Co, Al, Ho, and Tb corresponding to the indication at the bottom of the diagram) displayed in combination with Nd are respectively displayed with legends that are not a white circle (∘). For example, in the diagram displaying Nd and B, Nd is displayed as a white circle (∘), and B was displayed as a black circle () having roughly the same diameter as the legend of Nd. Example 5 also showed similar analysis results.

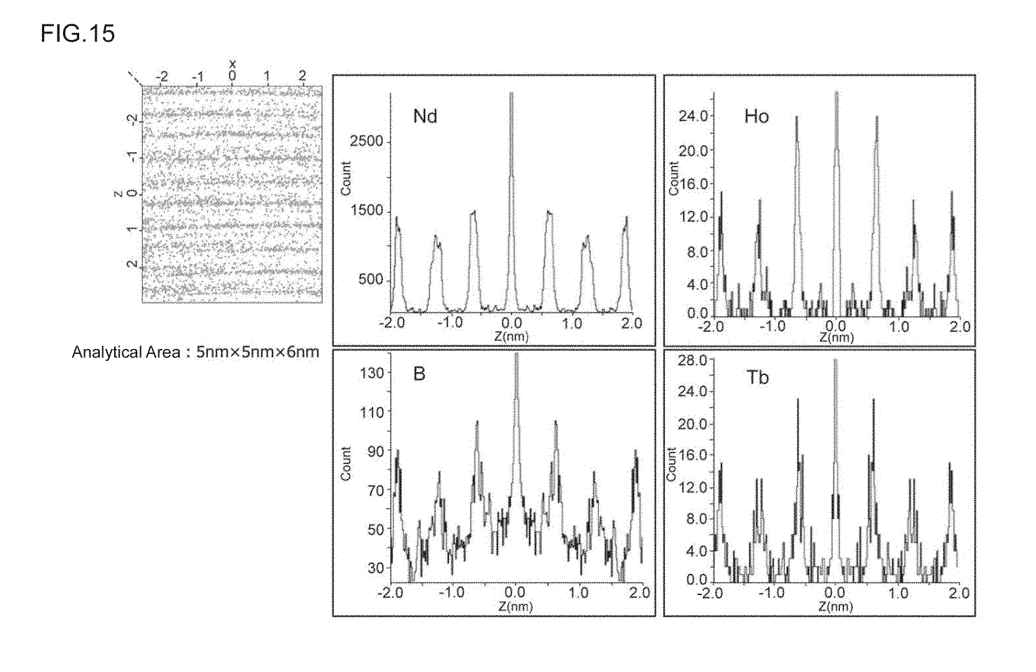

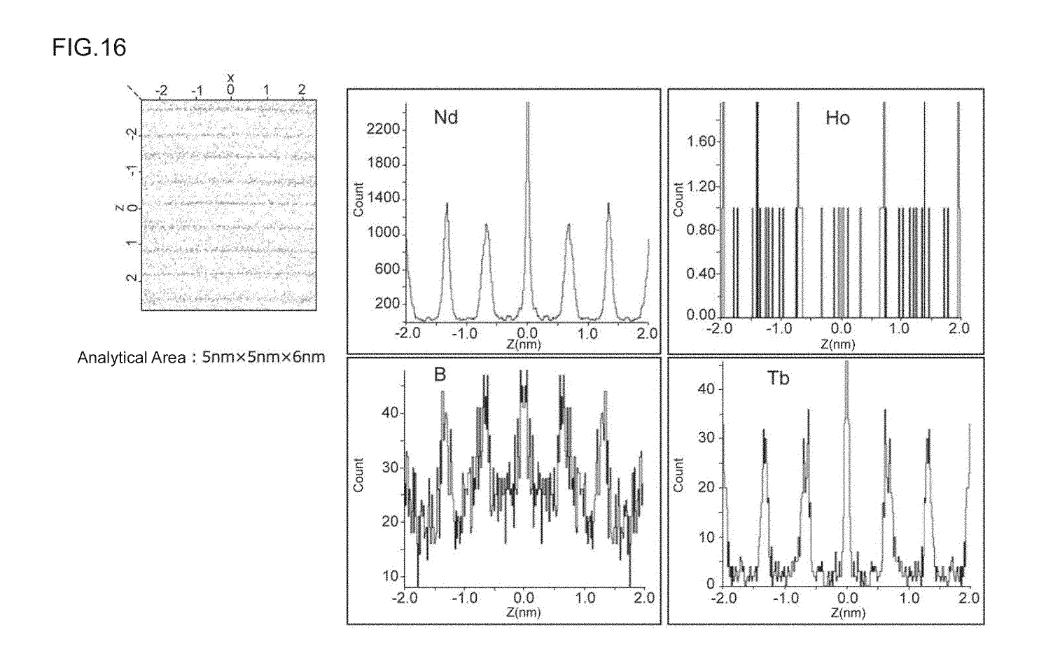

Moreover, the distributions of Nd, Ho, B, and Tb in an atom layer (c axis direction) of crystals containing the main phases of Example 3 and Example 5 were respectively measured using the Spatial Distribution function. Measurement was performed with reference to Brian P. Geiser, Thomas F. Kelly, David J. Larson, Jason Schneir and Jay P. Roberts, “Spatial Distribution Maps for Atom Probe Tomography”, Microscopy and Microanalysis, 13 (2007) pp 437-447. The measurement results of Example 5 are shown in FIG. 15, and the measurement results of Example 3 are shown in FIG. 16.

As shown in FIG. 15 and FIG. 16, in Example 3 and Example 5, Nd, Ho, B, and Tb all have peaks at positions of a multiple of 0.6 nm. In both FIG. 15 and FIG. 16, because the measurement results of B are distorted in comparison to the measurement values of other elements, it is assumed that, in this embodiment, B has been substituted by the elements L.

### Comparative Example 2

Comparative Example 2 was obtained from the raw material alloy containing the respective elements in the composition shown in FIG. 10 by using a rapid solidification device. Table 2 shows the analytical values of the alloy of Comparative Example 2 based on ICP emission spectrometry.

TABLE 2
(wt %)

| | Nd | Tb | Sm | B | Al | Cu | Co | Nb | Fe |
|---|---|---|---|---|---|---|---|---|---|
| Comparative | 25.768 | 4.368 | — | 0.967 | 0.382 | 0.090 | 0.850 | 0.180 | Remainder |
| Example 2 | | | | | | | | | |

Subsequently, the alloy was dispersed in a solvent, an additive was placed in the dispersed solution, the dispersed solution was agitated to perform reduction reaction, and the alloy was thereby pulverized. The powder particle size D₅₀ of the obtained alloy fine powder was 3 to 11 μm. The particle size was measured using a permissible substitute of the laser diffraction-type particle size distribution measuring device SALD-2300 manufactured by Shimadzu Corporation.

The pulverized raw material alloy was filled in a molding cavity and subject to compression molding at a molding pressure of 2 t/cm² upon applying a magnetic field of 19 kOe, and further subject to magnetization. The obtained compact was subject to a heat treatment process in a vacuum condition of 2×10¹ Torr under the heat treatment conditions shown in FIG. 17. After the completion of the heat treatment process, the compact was cooled to room temperature and then removed from the cavity to obtain the rare earth permanent magnet of Comparative Example 2. Comparative Example 2 is a magnet in a state where the main phase and the grain boundary phase were formed.

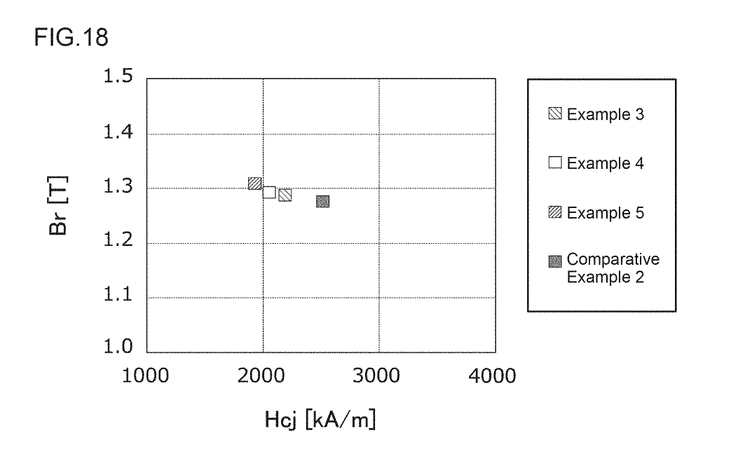

The magnetic properties of the rare earth permanent magnets of Example 3 to Example 5 and Comparative Example 2 were measured using a permissible substitute of the TPM-2-085 pulse excitation-type magnet measuring device (with a sample temperature variable device) manufactured by Toei Industry Co., Ltd. The measurement results are shown in FIG. 17 and FIG. 18. Note that, in FIG. 18, the unit [kG] of the residual magnetic flux density Br shown in FIG. 17 was converted into [T]. Moreover, the unit [kOe] of the coercive force H_{cj} was converted into [MA/m].

### Reference Example 1, Reference Example 2

This embodiment can improve the residual magnetic flux density Br by suppressing the B content and substituting B by Co. Because the residual magnetic flux density Br is proportional to the saturation magnetization, the saturation magnetization of this embodiment was measured, and the effect of this improvement in improving the residual magnetic flux density Br was confirmed based on the measurement results of the saturation magnetization.

In the test, foremost, two types of raw material alloys having different B contents as shown in Table 3 were prepared. Rare earth magnets can be obtained from the raw material alloys based on the predetermined production method of this embodiment. Reference Example 2 has a lower B content that Reference Example 1, and consequently the Co substitution content has increased.

The magnetic field-magnetization curve of Reference Example 1 and Reference Example 2 was measured using Lake Shore Cryotronics 7400 Series VSM. As shown in Table 3, the saturation magnetization of Reference Example 1 was 40.1557 (emu/g). The saturation magnetization of Reference Example 2 was 41.0184 (emu/g). In other words, Reference Example 2, which has a greater Co substitution content that Reference Example 1, exhibited greater saturation magnetization and thus larger residual magnetic flux density Br.

TABLE 3
(Content of each element: wt %)

| | | | | | | | Saturation |
|---|---|---|---|---|---|---|---|
| | | | | | | | magnet- |
| | | | | | | | ization |
| | Nd | B | Al | Cu | Co | Fe | (emu/g) |
| Reference | 30.490 | 0.900 | 0.200 | 0.050 | 0.900 | Remainder | 40.1557 |
| Example 1 | | | | | | | |
| Reference | 30.490 | 0.850 | 0.200 | 0.050 | 0.900 | Remainder | 41.0184 |
| Example 2 | | | | | | | |

The foregoing effect of improving the residual magnetic flux density Br is not impaired even when the elements A are contained as in this embodiment. In other words, this embodiment can improve both the residual magnetic flux density Br and the coercive force Hcj as a result of B being substituted by the elements L and the elements A being contained in the R—Fe—B layer. The improvement of these magnetic properties is as illustrated in FIG. 17 and FIG. 18.

The rare earth permanent magnet of this embodiment has a high magnetic moment, and comprises favorable magnetic properties. This rare earth permanent magnet can contribute to the downsizing, weight saving and cost reduction of electric motors, marine aero generators, and industrial motors.

### INDUSTRIAL APPLICABILITY

According to several modes of the present disclosure, it is possible to improve the magnetic properties of a rare earth permanent magnet comprising a main phase containing Nd, Fe, and B.

### REFERENCE SIGNS LIST

100 Crystal structure of unit cell

101 Fe layer

102 R—Fe—B layer

200 Main phase

300 Grain boundary phase

400 Sub phase

1. A rare earth permanent magnet comprising a main phase containing:
one or more elements R selected from a group consisting of Nd and Pr;
one or more elements L selected from a group consisting of Co, Be, Li, Al and Si;
one or more elements A selected from a group consisting of Tb, Sm, Gd, Ho and Er;
Fe; and
B,
wherein crystals forming the main phase belong to P4₂/mnm, and some B atoms occupying a 4f site of the crystals are substituted by atoms of the elements L.

2. The rare earth permanent magnet according to claim 1, wherein some atoms selected from a group consisting of Nd atoms occupying the 4f site, Fe atoms occupying a 4c site, and Fe atoms occupying a 8j site of the crystals belonging to P4₂/mnm are substituted by atoms of the elements L.

3. A rare earth permanent magnet comprising a main phase containing:
one or more elements R selected from a group consisting of Nd and Pr;
one or more elements L selected from a group consisting of Co, Be, Li, Al and Si;
one or more elements A selected from a group consisting of Tb, Sm, Gd, Ho and Er;
Fe; and
B.

4. The rare earth permanent magnet according to claim 3, wherein crystals forming the main phase cyclically include
a R—Fe—B layer containing:
one or more of the elements R selected from a group consisting of Nd and Pr; Fe; and B, and
an Fe layer, and
wherein some B atoms are substituted by atoms of the elements L, and the R—Fe—B layer contains atoms of the elements A.

5. The rare earth permanent magnet according to claim 1, wherein the rare earth permanent magnet comprises the main phase and a grain boundary phase formed between the main phases, and
wherein, relative to a total weight of the rare earth permanent magnet,
a content of the elements R is 20 to 35 wt %,
a content of B is 0.80 to 0.99 wt %,
a total content of one or more elements selected from a group consisting of Co, Be, Li, Al, Si, Cu, Nb, Zr, Ti and Ga is 0.8 to 2.0 wt %, and
a total content of one or more of the elements A selected from a group consisting of Tb, Sm, Gd, Ho and Er is 2.0 to 10.0 wt %.

6. The rare earth permanent magnet according to claim 3, wherein the rare earth permanent magnet comprises the main phase and a grain boundary phase formed between the main phases, and
wherein, relative to a total weight of the rare earth permanent magnet,
a content of the elements R is 20 to 35 wt %,
a content of B is 0.80 to 0.99 wt %,
a total content of one or more elements selected from a group consisting of Co, Be, Li, Al, Si, Cu, Nb, Zr, Ti and Ga is 0.8 to 2.0 wt %, and
a total content of one or more of the elements A selected from a group consisting of Tb, Sm, Gd, Ho and Er is 2.0 to 10.0 wt %.

7. The rare earth permanent magnet according to claim 1, wherein the grain boundary phase formed between the main phases contains one or more elements selected from a group consisting of Al, Cu, Nb, Zr, Ti and Ga.

8. The rare earth permanent magnet according to claim 3, wherein the grain boundary phase formed between the main phases contains one or more elements selected from a group consisting of Al, Cu, Nb, Zr, Ti and Ga.

9. The rare earth permanent magnet according to claim 1, wherein the rare earth permanent magnet is produced using alloy particles having a powder particle size D₅₀ of 2 to 18 μm.

10. The rare earth permanent magnet according to claim 3, wherein the rare earth permanent magnet is produced using alloy particles having a powder particle size D₅₀ of 2 to 18 μm.

11. The rare earth permanent magnet according to claim 1, wherein a sintered density of the rare earth permanent magnet is 6 to 8 g/cm³.

12. The rare earth permanent magnet according to claim 3, wherein a sintered density of the rare earth permanent magnet is 6 to 8 g/cm³.

13. A raw material alloy of the rare earth permanent magnet according to claim 1, wherein the raw material alloy contains:
the elements R; one or more elements selected from a group consisting of Co, Be, Li, Al, Si, Cu, Nb, Zr, Ti and Ga;
the elements A;
Fe; and
B, and
wherein the raw material alloy is alloy particles having a powder particle size D₅₀ of 2 to 18 μm.

14. A raw material alloy of the rare earth permanent magnet according to of claim 3, wherein the raw material alloy contains:
the elements R; one or more elements selected from a group consisting of Co, Be, Li, Al, Si, Cu, Nb, Zr, Ti and Ga;
the elements A;
Fe; and
B,
wherein and the raw material alloy is alloy particles having a powder particle size D₅₀ of 2 to 18 μm.

15. A method of producing a rare earth permanent magnet including a heat treatment step of retaining, at a first treatment temperature, a raw material alloy containing:
one or more elements R selected from a group consisting of Nd and Pr;
one or more elements selected from a group consisting of Co, Be, Li, Al, Si, Cu, Nb, Zr, Ti and Ga;
one or more elements A selected from a group consisting of Tb, Sm, Gd, Ho and Er;
Fe; and
B,
wherein the rare earth permanent magnet comprises a main phase containing: the elements R, one or more elements L selected from a group consisting of Co, Be, Li, Al and Si; the elements A; Fe; and B, crystals forming the main phase belong to P4₂/mnm, and some B atoms occupying a 4f site of the crystals are substituted by atoms of the elements L.

16. A method of producing a rare earth permanent magnet including a heat treatment step of retaining, at a first treatment temperature, a raw material alloy containing:
one or more elements R selected from a group consisting of Nd and Pr;
one or more elements selected from a group consisting of Co, Be, Li, Al, Si, Cu, Nb, Zr, Ti and Ga;
one or more elements A selected from a group consisting of Tb, Sm, Gd, Ho and Er;
Fe; and
B,
wherein the method forms a main phase which cyclically includes a R—Fe—B layer containing the elements R, Fe, and B, and an Fe layer, and in which some B atoms are substituted by atoms of one or more elements L selected from a group consisting of Co, Be, Li, Al and Si, and the R—Fe—B layer contains atoms of the elements A.

17. The method of producing a rare earth permanent magnet according to claim 15, further including a heat treatment step of lowering the first treatment temperature to a second treatment temperature after a holding time of the first treatment temperature elapses, and holding the raw material alloy at the second treatment temperature, wherein the method forms a grain boundary phase between the main phases.

18. The method of producing a rare earth permanent magnet according to claim 16, further including a heat treatment step of lowering the first treatment temperature to a second treatment temperature after a holding time of the first treatment temperature elapses, and holding the raw material alloy at the second treatment temperature, wherein the method forms a grain boundary phase between the main phases.
